(19) United States
(12) Patent Application Publication
(10) Pub. No.: US 2012/0017768 A1
(43) Pub. Date: Jan. 26, 2012

(54) LIQUID TANK AND COOKING DEVICE

(76) Inventors: Hiroki Kitayama, Osaka (JP); Takao Murai, Osaka (JP); Noriko Ina, Osaka (JP)

(21) Appl. No.: 13/258,800

(22) PCT Filed: Apr. 9, 2010
(86) PCT No.: PCT/JP2010/056427

§ 371 Date: Sep. 22, 2011

(30) Foreign Application Priority Data
Apr. 16, 2009 (JP) 2009 099702
Apr. 16, 2009 (JP) 2009 100192

(51) Int. Cl. A47J 27/00

(52) U.S. Cl. 99/324

(57) ABSTRACT

A water tank 104 includes a tank main body 130 for storing water therein, and a decorative plate 131 attached to the tank main body 130 and having a height H1 higher than a height H2 of the tank main body. A handle portion is provided in a decorative plate 131 side bottom face of the tank main body 130. At an upper end of the decorative plate 131, a holding recess portion 139 is formed so as to allow a user to hold a top face of the tank main body 130 while gripping the handle portion.

### TECHNICAL FIELD

The present invention relates to a liquid tank for use in, for example, cooking devices and the like.

### BACKGROUND ART

Among conventional devices provided with a liquid tank is a cooking device disclosed in JP 2007-183098 A (Patent Literature 1). This cooking device, in some cases, includes a casing, a heating chamber provided in the casing, a water tank removably set at a lower portion of a front face of the casing, and a steam generator to which water in the water tank is supplied.

The water in the water tank, after heated by the steam generator to be steam, is fed to the heating chamber. In this process, water in the water tank decreases along with the feed of steam to the heating chamber.

When the water in the water has run out, a user removes the water tank from the casing and carries the tank to a water-faucet setting place. Then, the user opens the water tap to let water into the water tank through the water faucet, and thereafter sets the water tank again at the front-face lower portion of the casing.

In this case, when the water tank is set at the front-face lower portion of the casing, the front face of the water tank is exposed. That is, the casing holds the water tank with the front face of the water tank exposed outside.

Therefore, with the water tank set in the casing, there is a problem that the appearance of the front face of the casing is impaired.

### CITATION LIST

### Patent Literature

PATENT LITERATURE 1: JP 2007-183098 A

### SUMMARY OF INVENTION

### Technical Problem

Accordingly, an object of the present invention is to provide a liquid tank, as well as a cooking device equipped with the liquid tank, capable of preventing degradations in appearance grade of a device as a setting destination.

### Solution to Problem

In order to solve the above object, a liquid tank of the present invention comprises:

a tank main body for storing liquid therein;

a decorative plate attached to the tank main body and being higher than a height of the tank main body;

a handle portion provided in a decorative plate side bottom face of the tank main body; and

a holding recess portion formed at an upper end of the decorative plate so as to allow a user to hold a top face of the tank main body while gripping the handle portion.

According to the liquid tank of the above structure, since the decorative plate higher than the tank main body is attached to the tank main body, the tank main body can be concealed by the decorative plate. Therefore, in setting of the liquid tank on a device, positioning the decorative plate on an outer side blocks the tank main body from being exposed outside, thus making it possible to prevent degradations in appearance grade of the setting-destination device.

Also, since the handle portion is provided in the decorative plate side bottom face of the tank main body, the user is allowed to grasp the handle portion so that the tank main body can be removed easily from the setting-destination device.

Further, the holding recess portion is formed at an upper end of the decorative plate so as to allow the user to hold the top face of the tank main body while gripping the handle portion. Therefore, the user is allowed to grasp the handle portion in the decorative plate side bottom face of the tank main body by, for example, fingers other than the thumb while holding the top face of the tank main body by, for example, the thumb, so that the tank main body can be held stably.

In this connection, the water tank shown in JP 2007-183098 A, from the viewpoint of preventing water leakage during carriage, is preferably comprised of a tank main body having an opened upper end, and a cover which is removably attached to the tank main body and which works for opening and closing the opening of the upper end of the tank main body.

However, with the water tank comprised of the tank main body and the cover, the user is required to attach and remove the cover for resupply of water into the water tank.

Therefore, the water tank, which is comprised of the tank main body and the cover, has a problem of involving laborious attachment and removal of the cover, resulting in a poor easiness of use for the user.

A liquid tank in one embodiment can solve the above-described problem.

That is, the liquid tank of one embodiment comprises:

a recess portion provided in the top face of the tank main body; and

an upper-limit display portion provided in a side face of the tank main body and showing an upper limit of liquid permissible quantity for the tank main body, wherein

in a bottom portion of the recess portion, a plurality of through holes are provided so as to extend through the bottom portion, and

a height of the bottom portion of the recess portion relative to the bottom face of the tank main body is substantially coincident with a height of the upper-limit display portion relative to the bottom face of the tank main body.

According to the liquid tank of this embodiment, the user pours liquid, which is to be resupplied into the tank main body, into the recess portion provided in the top face of the tank main body. Then, the liquid passes through the plurality of through holes at the bottom portion of the recess portion, flowing into the tank main body.

Thus, the work of resupplying liquid into the tank main body involves no such attachment and removal of the cover as described above, allowing the time and labor for the work to be cut down, giving a good easiness of use for the user.

Also, during the resupply of liquid into the tank main body, when the resupply liquid level has reached an upper limit of liquid permissible quantity for the tank main body, the liquid surface is exposed out from the plurality of through holes provided in the bottom portion of the recess portion for the reason that the bottom portion of the recess portion is provided generally flush with the upper-limit display portion showing the upper limit of liquid permissible quantity for the tank main body.

Thus, the user can easily and securely ascertain from upward that the liquid quantity in the tank main body has reached the upper limit of liquid permissible quantity.

A cooking device of this invention comprises:

a casing; and

the liquid tank, wherein

the casing has a housing section for housing the tank main body of the liquid tank, and

with the tank main body housed, a surface of the decorative plate and a surface of the casing adjoining the decorative plate are generally flush with each other.

According to the cooking device of this structure, when the tank main body is housed in the housing section, the surface of the casing adjacent to the decorative plate and the surface of the decorative plate are generally flush with each other. Thus, the appearance grade as viewed from the decorative plate side can be made high.

In one embodiment, the casing has a fitting recess portion to which the decorative plate is to be fitted;

position alignment parts for aligning a position of the surface of the decorative plate with a position of the surface of the casing are provided in the decorative plate and the fitting recess portion, respectively.

According to the cooking device of this embodiment, position alignment parts for aligning the position of the surface of the decorative plate with the position of the surface of the casing are provided in the decorative plate and the fitting recess portion, respectively. Therefore, the surface of the decorative plate can be prevented from being misaligned relative to the surface of the casing, so that degradations in appearance grade of the casing can be prevented.

A cooking device of this invention comprises:

a casing;

the liquid tank removably attached to the casing;

a steam generator for evaporating liquid derived from the liquid tank to generate steam; and

a heating chamber for heating a cooking object by using the steam generated by the steam generator.

According to the cooking device of this structure, since the liquid tank of the invention is removably attached to the casing, degradations in appearance grade of the front face of the casing can be prevented.

Preferably, in a case where substantial time has elapsed since the preceding heating of the cooking object, the liquid within the tank main body should be replaced with new liquid before heating of the cooking object.

Doing such replacement of the liquid within the tank main body causes increases in the number of times of resupply of the liquid within the tank main body. However, in the case where the recess portion for resupplying the liquid into the tank main body is provided in the top face of the tank main body, since the work of resupply of the liquid into the tank main body is no time-taking work, easiness of use is satisfactory.

### Advantageous Effects of Invention

According to the liquid tank of the invention, the decorative plate higher than the tank main body is attached to the tank main body so that the tank main body can be concealed by the decorative plate, preventing the tank main body from being exposed outside. Thus, degradations in appearance grade of the setting-destination device can be prevented.

Also, since the handle portion is provided in the decorative plate side bottom face of the tank main body, the user is allowed to grasp the handle portion so that the tank main body can be removed easily from the setting-destination device.

Further, the holding recess portion is formed at an upper end of the decorative plate so as to allow the user to hold the top face of the tank main body while gripping the handle portion. Therefore, the user is allowed to grasp the handle portion in the decorative plate side bottom face of the tank main body by, for example, fingers other than the thumb while holding the top face of the tank main body by, for example, the thumb, so that the tank main body can be held stably.

According to the cooking device of this invention, when the tank main body of the liquid tank is housed in the housing section, the surface of the casing adjacent to the decorative plate and the surface of the decorative plate are generally flush with each other. Thus, the appearance grade as viewed from the decorative plate side can be made high.

According to the cooking device of this invention, since the liquid tank of the invention is removably attached to the casing, degradations in appearance grade of the front face of the casing can be prevented.

### BRIEF DESCRIPTION OF DRAWINGS

FIG. 1 is a schematic front view of a cooking device according to an embodiment of the present invention;

FIG. 2 is a schematic sectional view of the cooking device;

FIG. 3 is an outline perspective view of a water tank according to an embodiment of the invention;

FIG. 4 is an outline perspective view of the water tank as viewed from a rear diagonal upward of the water tank;

FIG. 5 is a schematic sectional view of main part of the water tank;

FIG. 6 is an outline bottom view of the water tank;

FIG. 7 is an outline perspective view of the water tank, an operation panel and a housing section; and

FIG. 8 is a schematic view for explaining an example of the way how the water tank is held.

### DESCRIPTION OF EMBODIMENTS

Hereinbelow, a liquid tank and a cooking device of the present invention will be described in detail by embodiments thereof illustrated in the accompanying drawings.

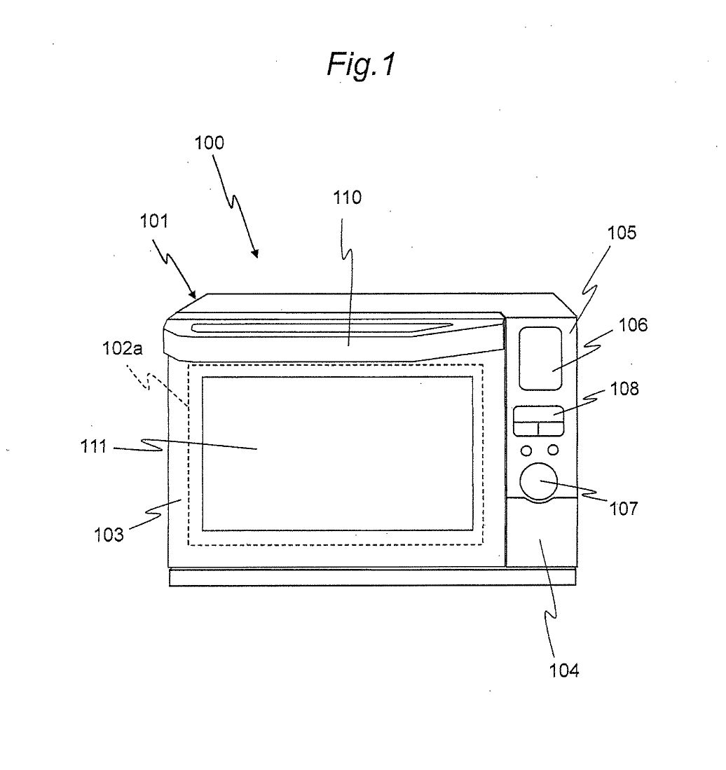

FIG. 1 is a schematic front view of a cooking device 100 according to an embodiment of the invention as viewed from the front face side.

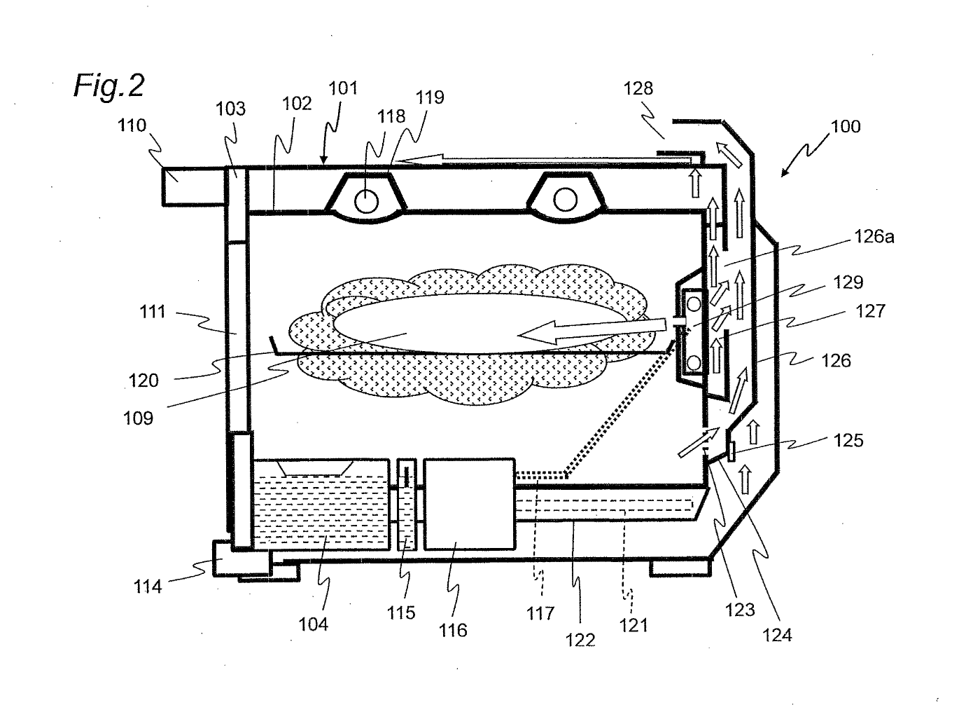

The cooking device 100 includes a rectangular parallelepiped-shaped casing 101, a heating chamber 102 (see FIG. 2) provided in the casing 101, an opening/closing door 103 rotatably fitted on the front side of the casing 101, and a water tank 104 removably fitted to the casing 101. It is noted that the water tank 104 is as an example of the liquid tank.

The opening/closing door 103 rotates about a lower end portion to open and close an opening 102a of the heating chamber 102. A handle 110 is attached at an upper portion of the opening/closing door 103. Also, heat-resistant glass 111 is set at a generally central portion of the opening/closing door 103, so that a user is allowed to discern an internal state of the heating chamber 102 through the heat-resistant glass 111. In the rear face of the opening/closing door 103, a packing (not shown) made of heat-resistant resin is fixedly set so as to surround the heat-resistant glass 111. When the opening/closing door 103 is closed, the packing is brought into strong, close contact with a peripheral portion of the opening 102a of the heating chamber 102. As a result of this, leakage of steam or the like within the heating chamber 102 from between the opening/closing door 103 and the peripheral portion of the opening 102a of the heating chamber 102 is prevented.

An operation panel 105 is provided on the right side of the front face of the casing 101. This operation panel 105 has a liquid crystal display part 106, a dial 107 and a plurality of buttons 108. Also, the front face of the water tank 104 is exposed on a lower side of the dial 107.

FIG. 2 is a schematic sectional view of the cooking device 100. Reference signs in FIG. 2 denote a dew receiving container 114, a water level sensor 115, a water supply pump 116, a water supply pipe 117, an upper heater 118, an upper heater cover 119, a tray 120, a lower heater 121, a heat shielding plate 122, an exhaust port 123, an exhaust port cover 124, an exhaust thermo sensor 125, an exhaust duct 126, a cold-air inlet opening 126a, a cold-air path 127, a dilution exhaust port 128, and a steam generator 129. Although not shown, a magnetron for generating microwaves is also set in the casing 101. In addition, the steam generator 129 is an example of the steam generating device.

The water supply pump 116 sucks water from within the water tank 104 and feeds the water via the water supply pipe 117 to the steam generator 129. This steam generator 129 is capable of heating the water derived from the water supply pump 116 to generate steam, and then supplying the generated steam to within the heating chamber 102 or further heating the steam to make it into superheated steam and supply the superheated steam into the heating chamber 102. It is noted here that the term, superheated steam, refers to steam that is heated to a superheated state of 100° C. or higher.

The cooking object 109 can be heated by steam or superheated steam derived from the steam generator 129 and by radiant heat from the upper heater 118 and the lower heater 121. A ceiling wall of the heating chamber 102 is provided under the upper heater 118, and a bottom wall of the heating chamber 102 is provided above the lower heater 121. The upper heater 118 and the lower heater 121 are not exposed into the heating chamber 102.

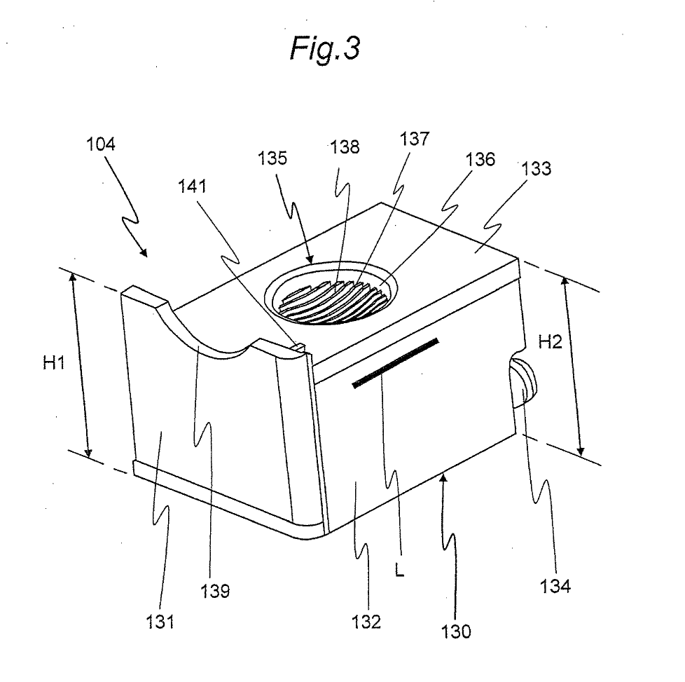

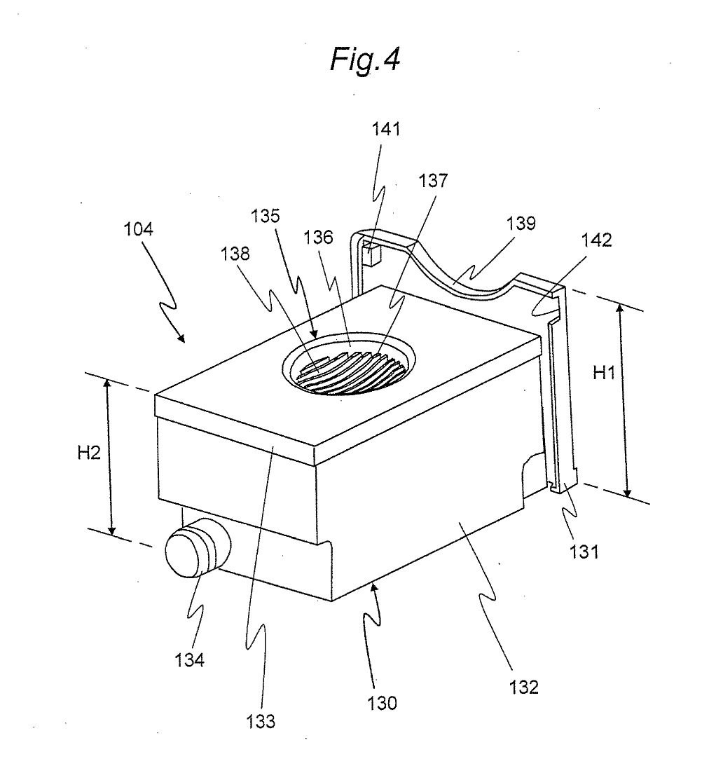

FIG. 3 is an outline perspective view of the water tank 104 as viewed from a front diagonal upward thereof. FIG. 4 is an outline view of the water tank 104 as viewed from a rear diagonal upward thereof.

As shown in FIGS. 3 and 4, the water tank 104 includes a tank main body 130 for storing water therein, and a decorative plate 131 attached on the front side of the tank main body 130. It is noted that the water is an example of liquid.

The tank main body 130 has a water storage part 132 with its upper end opened, and a cover part 133 removably attached at an upper portion of the water storage part 132.

A linear-shaped full-water line L that shows an upper limit of water permissible quantity for the tank main body 130 is provided on one inner side face of the water storage part 132. The water storage part 132 is formed from transparent resin so as to allow the full-water line L to be discerned from outside. Also, a water supply port 134 for supplying water to the water level sensor 115 is provided at a rear portion of the water storage part 132.

An opening/closing valve (not shown) is provided in the water supply port 134. The water supply port 134 and the opening/closing valve are so structured that when the water tank 104 is set to the casing 101, the opening/closing valve is opened, allowing water to flow out from the water supply port 134 and, on the other hand, when the water tank 104 is removed from the casing 101, the opening/closing valve is closed, blocking water from flowing out from the water supply port 134. As the structure of the water supply port 134 and the opening/closing valve, there is a known structure identical to a structure of the oil tank for kerosine stoves as an example. It is noted that the full-water line L may be either a linear-shaped protruding portion or a linear-shaped groove portion. The full-water line L is an example of an upper-limit display portion.

The cover part 133 is molded from transparent resin or non-transparent resin. A water-pouring recess portion 135 that defines a generally cylindrical-shaped space is provided in a top face of the cover part 133. The water-pouring recess portion 135 is composed of a generally cylindrical-shaped peripheral wall portion 136, and a bottom portion 137 adjoining a lower end portion of the peripheral wall portion 136. The upper end portion of the peripheral wall portion 136 is so curved that its diameter decreases toward the bottom portion 137. Then, the bottom portion 137 is grating-shaped, having a plurality of generally rectangular-shaped through holes 138 as viewed from the top. As a result, the water storage part 132 can be resupplied with water by pouring water into the water-pouring recess portion 135. It is noted that the water-pouring recess portion 135 is an example of a recess portion.

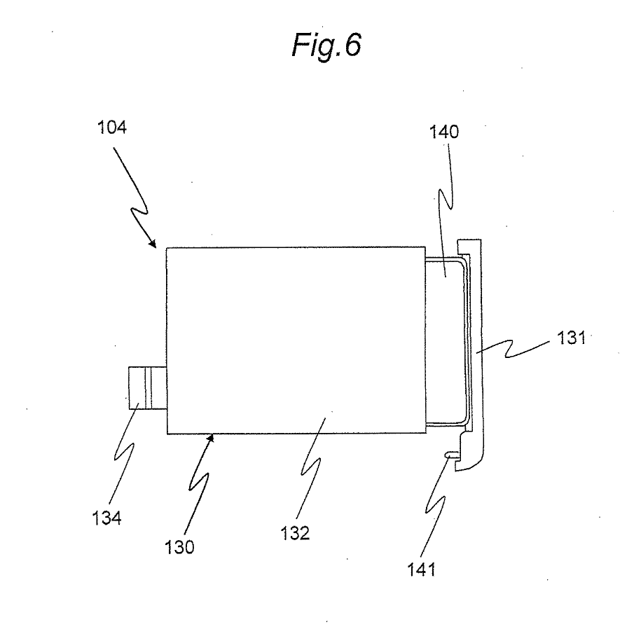

A height H1 of the decorative plate 131 is larger than a height H2 of the tank main body 130. Also, a holding recess portion 139 is formed at an upper end of the decorative plate 131 so that a user is enabled to press the top face of the cover part 133 while gripping a handle portion (see FIG. 6). The holding recess portion 139 is generally circular arc-shaped as viewed from forward. Also, when the water tank 104 is set to the casing 101, a lower projecting portion of the dial 107 is clearance-fitted to the holding recess portion 139 of the decorative plate 131.

Further, in an upper end portion of the decorative plate 131, a first protruding portion 141 is provided so as to be located on one side of the holding recess portion 139 while a first recess portion 142 is provided so as to be located on the other side of the holding recess portion 139. It is noted that the first protruding portion 141 and the first recess portion 142 are an example of a position alignment part.

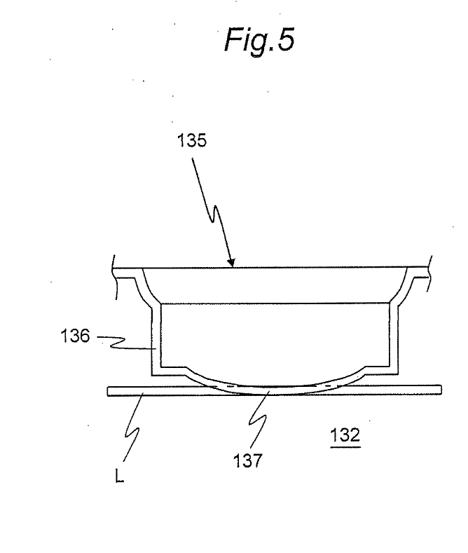

FIG. 5 is a schematic sectional view of main part of the water tank 104.

Portions other than the peripheral edge portion of the bottom portion 137 of the water-pouring recess portion 135 are so curved as to project toward inside the water storage part 132. That is, a cross section of the bottom portion 137 of the water-pouring recess portion 135 as it is cut by a vertical plane is generally circular arc-shaped. Then, a height of the lower end portion of the bottom portion 137 of the water-pouring recess portion 135 is coincident with the height of the full-water line L. It is noted here that the terms, “height of the lower end portion of the bottom portion 137 of the water-pouring recess portion 135” and “height of the full-water line L,” refer to heights relative to the bottom face of the water storage part 132.

FIG. 6 is an outline view of the water tank 104 as viewed from below.

A handle portion 140 formed of a recess portion is provided on the bottom face of the water storage part 132 on one side on which the decorative plate 131 is provided. This handle portion 140 is generally rectangular-shaped as viewed from below, and so sized as to allow a user's finger to be inserted thereinto.

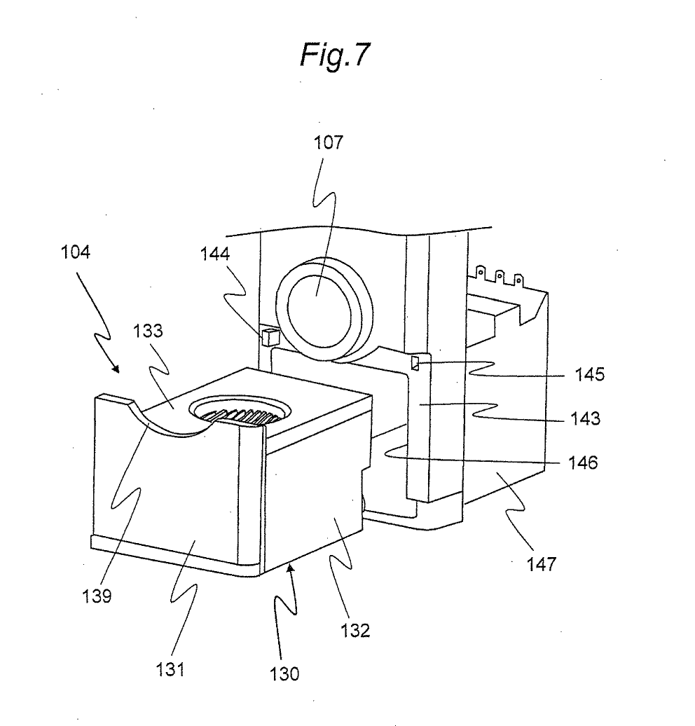

FIG. 7 is an outline perspective view of the water tank 104, an operation panel 105 and a housing section 147.

A fitting recess portion 143, to which the decorative plate 131 is to be fitted, is provided at a lower portion of the front face of the operation panel 105. A second protruding portion 144, a second recess portion 145 and an insertion opening 146 are provided in the fitting recess portion 143. For setting of the water tank 104 to the casing 101, the user inserts the tank main body 130 into the insertion opening 146 from forward, sets the tank main body 130 housed in the housing section 147 while setting the decorative plate 131 fitted to the fitting recess portion 143. Then, the first protruding portion 141 of the decorative plate 131 is fitted into the second recess portion 145 of the fitting recess portion 143, and the second protruding portion 144 of the fitting recess portion 143 is fitted into the first recess portion 142 of the decorative plate 131, so that the front face of the decorative plate 131 is positionally aligned relative to the front face of the operation panel 105. In order that such positional alignment can be accomplished, the first protruding portion 141, the first recess portion 142, the second recess portion 145 and the second protruding portion 144 are set in terms of length or depth. It is noted here that the term “front face of the operation panel 105” refers to a surface of the operation panel 105 on which the liquid crystal display part 106 and the like are provided, while the term “front face of the decorative plate 131” refers to a surface of the decorative plate 131 on the side opposite to the tank main body 130 side surface. A state expressed as “the front face of the decorative plate 131 is positionally aligned relative to the front face of the operation panel 105” refers to a state that the front face of the operation panel 105 and the front face of the decorative plate 131 are contained generally in one identical plane. It is noted that the second protruding portion 144 and the second recess portion 145 are an example of the positioning part.

According to the cooking device 100 having structure as described above, with the water tank 104 set to the casing 101, since the height H1 of the decorative plate 131 is larger than the height H2 of the tank main body 130, the tank main body 130 can be concealed by the decorative plate 131. Therefore, the tank main body 130 is kept from being exposed outside, so that degradations in appearance grade of the cooking device 100 can be prevented.

Also, since the handle portion 140 is provided in the decorative plate 131 side bottom face of the tank main body 130, the user can draw out the tank main body 130 easily from the cooking device 100 by gripping the handle portion 140.

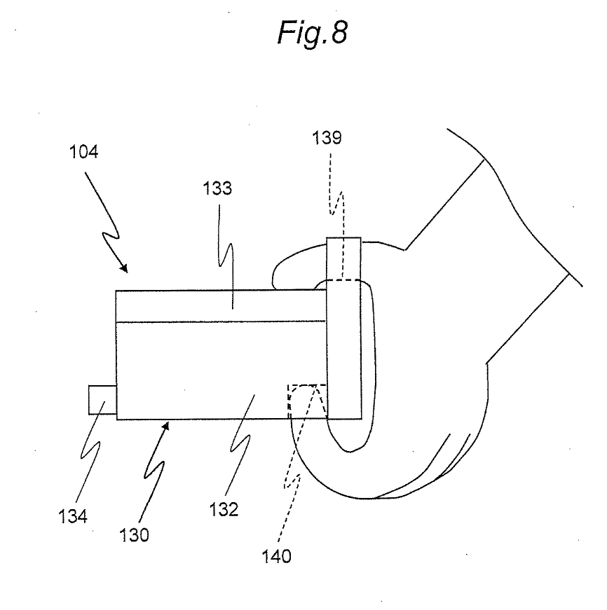

Also, by virtue of the holding recess portion 139 provided at the upper end of the decorative plate 131, the user is allowed to grasp the handle portion 140 in the decorative plate 131 side bottom face of the water storage part 132 by, for example, fingers other than the thumb while holding the top face of the cover part 133 by, for example, the thumb as shown in FIG. 8, so that the tank main body 130 can be held stably.

Moreover, when the tank main body 130 is housed in the housing section 147 with the decorative plate 131 fitted into the fitting recess portion 143, the first protruding portion 141 of the decorative plate 131 is fitted to the second recess portion 145 of the fitting recess portion 143 while the second protruding portion 144 of the fitting recess portion 143 is fitted to the first recess portion 142 of the decorative plate 131, so that the front face of the operation panel 105 and the front face of the decorative plate 131 are generally flush with each other. Accordingly, the cooking device 100 can be maintained good in appearance grade as viewed from forward.

Also, when the user pours water into the water-pouring recess portion 135 of the top face of the cover part 133, the water passes through the plurality of through holes 138 of the bottom portion 137 of the water-pouring recess portion 135 so as to flow into the water storage part 132.

Accordingly, even without doing fitting and removal of the cover part 133 by the user, water can be easily resupplied into the water storage part 132, making the water tank 104 easy to use.

During resupply of water into the water storage part 132, when the water level reaches the full-water line L, there is a state that the water surface exists within the plurality of through holes 138, allowing the water surface to be visually observed.

Thus, the user can easily and securely ascertain that the water surface has reached the full-water line L.

Also, by blocking the opening of the upper end of the water storage part 132 by the cover part 133, even in carriage of the water tank 104 after water resupply, the water within the water storage part 132 is less likely to leak outside.

Also, even if the water surface has exceeded the full-water line L to some extent, water can be retained in the water-pouring recess portion 135, so that the water can be prevented from leaking out from the water-pouring recess portion 135.

Also, since a cross section resulting from cutting a central portion of the bottom portion 137 of the water-pouring recess portion 135 by a vertical plane is generally circular arc-shaped, spattering of water poured to the central portion of the bottom portion 137 of the water-pouring recess portion 135 can be reduced.

In this embodiment, the steam generator 129 having the function of generating superheated steam is mounted on the cooking device 100. Instead, a steam generating device working only for generating steam and having no function of generating superheated steam may be mounted on the cooking device 100.

In this embodiment, a handle portion formed of a recess portion is provided in the decorative plate 131 side bottom face of the water storage part 132. Instead, a handle portion formed of a protruding portion as an example may be provided in the decorative plate 131 side bottom face of the water storage part 132.

In this embodiment, the holding recess portion 139 generally circular arc-shaped as viewed from forward is provided at the upper end of the decorative plate 131. Instead, a holding recess portion generally rectangular-shaped as viewed from forward as an example may be provided at the upper end of the decorative plate 131.

In this embodiment, the water-pouring recess portion 135 that defines a generally cylindrical-shaped space is provided at the top face of the cover part 133. Instead, a recess portion that defines a generally prismatic-shaped space as an example may be provided at the top face of the cover part 133.

In this embodiment, the bottom portion 137 of the water-pouring recess portion 135 provided in the top face of the cover part 133 is so formed as to have a plurality of through holes 138 generally rectangular-shaped as viewed from the top. Instead, the plurality of through holes 138 may be generally circular-shaped as viewed from the top, as an example.

In this embodiment, the bottom portion 137 formed from resin may be replaced with a bottom portion formed of a wire mesh as an example.

The liquid tank according to the present invention is applicable to not only, for example, microwave ovens using superheated steam, but also cooking devices such as ovens using superheated steam or IH (Induction Heating) cooking heaters.

The cooking device of this invention makes it possible to perform healthy cooking by using superheated steam or saturated steam in cooking heaters (including those using electric hot plates, such as IH heaters and electric heaters, or gas cooking stoves), microwave ovens and the like. For example, with the cooking device of the invention, superheated steam or saturated steam having temperatures of 100° C. or higher is fed to food surfaces, and superheated steam or saturated steam deposited on the food surfaces is condensed to give large amounts of condensed latent heat to the food, so that heat can be transferred to the food efficiently. Further, condensed water is deposited on the food surfaces and salinity and oil contents drip down along with the condensed water, so that the salinity and oil contents in the food can be reduced. Moreover, the heating chamber is internally filled with superheated steam or saturated steam so as to be put into a low-oxygen state, thus making it possible to achieve food oxidation-suppressed cooking.

The above embodiment has been described on a cooking device as an example of the device equipped with the liquid tank. However, the liquid tank of this invention may be applied to such devices as humidifiers or pesticide spraying machines.

### REFERENCE SIGNS LIST

100 cooking device
101 casing
102 heating chamber
104 water tank
129 steam generator
130 tank main body
131 decorative plate
132 water storage part
133 cover part
135 water-pouring recess portion
137 bottom portion
138 through hole
140 handle portion
141 first protruding portion
142 first recess portion
143 fitting recess portion
144 second protruding portion
145 second recess portion
146 insertion opening
L full-water line
147 housing section
H1 height of decorative plate
H2 height of tank main body

1. A liquid tank comprising:
a tank main body for storing liquid therein;
a decorative plate attached to the tank main body and being higher than a height of the tank main body;
a handle portion provided in a decorative plate side bottom face of the tank main body; and
a holding recess portion formed at an upper end of the decorative plate so as to allow a user to hold a top face of the tank main body while gripping the handle portion.

2. The liquid tank as claimed in claim 1, further comprising:
a recess portion provided in the top face of the tank main body; and
an upper-limit display portion provided in a side face of the tank main body and showing an upper limit of liquid permissible quantity for the tank main body, wherein
in a bottom portion of the recess portion, a plurality of through holes are provided so as to extend through the bottom portion, and
a height of the bottom portion of the recess portion relative to the bottom face of the tank main body is substantially coincident with a height of the upper-limit display portion relative to the bottom face of the tank main body.

3. The liquid tank as claimed in claim 2, wherein
a cross section of a central portion of the recess portion cut by a vertical plane has such a generally circular arc shape as to protrude toward the bottom face of the tank main body.

4. A cooking device comprising:
a casing; and
the liquid tank as defined in claim 1, wherein
the casing has a housing section for housing the tank main body of the liquid tank, and
with the tank main body housed, a surface of the decorative plate and a surface of the casing adjoining the decorative plate are generally flush with each other.

5. The cooking device as claimed in claim 4, wherein
the casing has a fitting recess portion to which the decorative plate is to be fitted;
position alignment parts for aligning a position of the surface of the decorative plate with a position of the surface of the casing are provided in the decorative plate and the fitting recess portion, respectively.

6. A cooking device comprising:
a casing;
the liquid tank as defined in claim 1 removably attached to the casing;
a steam generator for evaporating liquid derived from the liquid tank to generate steam; and
a heating chamber for heating a cooking object by using the steam generated by the steam generator.

7. A cooking device comprising:
a casing; and
the liquid tank as defined in claim 2 wherein
the casing has a housing section for housing the tank main body of the liquid tank, and
with the tank main body housed, a surface of the decorative plate and a surface of the casing adjoining the decorative plate are generally flush with each other.

8. A cooking device comprising:
a casing; and
the liquid tank as defined in claim 3 wherein
the casing has a housing section for housing the tank main body of the liquid tank, and
with the tank main body housed, a surface of the decorative plate and a surface of the casing adjoining the decorative plate are generally flush with each other.

9. A cooking device comprising:
a casing;
the liquid tank as defined in claim 2 removably attached to the casing;
a steam generator for evaporating liquid derived from the liquid tank to generate steam; and
a heating chamber for heating a cooking object by using the steam generated by the steam generator.

10. A cooking device comprising:
a casing;
the liquid tank as defined in claim 3 removably attached to the casing;
a steam generator for evaporating liquid derived from the liquid tank to generate steam; and
a heating chamber for heating a cooking object by using the steam generated by the steam generator.
